(19) United States
(12) Patent Application Publication
(10) Pub. No.: US 2012/0201735 A1
(43) Pub. Date: Aug. 9, 2012

(54) SYSTEM AND METHOD FOR MANUFACTURING SILICON CARBIDE PULVERULENT BODY

(75) Inventors: Byung Sook Kim, Seoul (KR); Jung Eun Han, Seoul (KR); Sang Myung Kim, Seoul (KR)

(73) Assignee: LG INNOTEK CO., LTD., Seoul (KR)

(21) Appl. No.: 13/392,269

(22) PCT Filed: Aug. 26, 2010
(86) PCT No.: PCT/KR2010/005753

§ 371 Date: Apr. 24, 2012

(30) Foreign Application Priority Data
Aug. 26, 2009 (KR) 10-2009-0079379
Aug. 27, 2009 (KR) 10-2009-0080014

(51) Int. Cl. C01B 31/36; B01J 19/00

(52) U.S. Cl. 423/345; 422/198

(57) ABSTRACT

Disclosed herein is a high-purity carbon silicon pulverulent body manufacturing method and system. That is, a high-purity carbon silicon pulverulent body manufacturing method of the present invention includes the step of producing a mixture consisting of silicon sources and carbon sources in a mixer; and the step of synthesizing silicon carbide (SiC) pulverulent body by heating the mixture at a vacuum degree of larger than 0.03 torr and equal to and less than 0.5 torr and at a temperature of equal to or larger than 1300° C. and equal to and less than 1900° C.

### TECHNICAL FIELD

The present invention relates to a method and a system for manufacturing silicon carbide pulverulent body.

### BACKGROUND ART

SiC (silicon carbide) and boron (B) are reinforced material having a higher tensile ratio. While Al₂O₃ is a representative of oxidant ceramics, SiC is widely used as a representing one of non-oxidant ceramics. SiC fiber, being reinforced material formed of ceramic and metal composite material, is vigorously explored in its use, and boron fiber is mainly used as epoxy reinforced material of high-end performance.

In particular, SiC having an excellent physical property is definitely to be plentifully used reinforced material, in a case only a cost problem more expensive than other reinforced material is solved.

SiC, as composite material, is one of the most essential carbides in a ceramic field.

In silicon carbide, β-phase having a cubic crystal structure and α-phase having a hexagonal crystal structure exist. β-phase is secure at a temperature range of 1400-1800° C., and α-phase is formed at more than 2000° C.

The molecular weight of SiC is 40.1, its specific gravity is 3.21, and it is decomposed around 2500° C. and over.

Since a pressure-less sintering was first succeeded in 1970s by U.S.A. G.E.'s Prochazka by the addition of boron and carbon, silicon carbide (SiC) has considerable high-temperature strength, has a superior property in anti-wear, anti-oxidation, anti-corrosion, creep resistance, etc. and thus draws attention as high-temperature structure material, and is currently extensively used high-level ceramic substance for such as a mechanical seal, a bearing, each kind of nozzle, a high-temperature cutting tool, an anti-fire plate, an abrasive, a reductant in steelmaking, and a lightning arrester.

In the prior art technology making such SiC pulverulent body, there exist an Acheson method, a direct reaction, a liquid polymer pyrolysis, and a high-temperature self-propagating synthesis and the like.

Such conventional technologies manufacture silicon carbide by mixing a solid state silicon source, for example, SiO₂ and Si, and a carbon source such kind as carbon and graphite and heat-processing thereof at 1350° C. through 2000° C. Such conventional technologies accompany a problem in SiC pulverulent body recovery rate, and have limits per purity and a relatively high composite temperature.

Furthermore, because silicon carbide is difficult to manufacture in bulk and needs additional processes such as a classification cleaning, there is a weak point that the cost of a manufactured carbon silicon pulverulent body is expensive due to a longer-taken manufacture time.

Thus, there is a desperate need of a manufacturing method of producing carbon silicon pulverulent body less low-costly and thus-way manufactured, high-purity, even carbon silicon pulverulent body, in a structure of importing overall amounts from abroad like our country.

### DISCLOSURE OF INVENTION

### Technical Problem

The present invention is intended to provide a high-purity carbon silicon pulverulent body manufacturing method and system capable of manufacturing carbon silicon pulverulent body non-expensively and easily.

Further, the present invention is to provide a method of manufacturing carbon silicon pulverulent body that can decrease a reaction energy needed for the production of carbon silicon pulverulent body in order to lower a heat-processing temperature, shorten a process time as well as obtain a higher recovery ratio.

### Solution To Problem

The present invention is related to a silicon carbide pulverulent body manufacturing method, characterized in that the method includes the step (a) of producing a mixture consisting of silicon sources and carbon sources in a mixer; and step (b) of synthesizing silicon carbide (SiC) pulverulent body by heating the mixture at a vacuum degree of larger than 0.03 torr and equal to and less than 0.5 torr and at a temperature of equal to or larger than 1300° C. and equal to and less than 1900° C.

Also, in the step (a), a mass ratio of the silicon sources and the carbon sources is characteristically equal to and more than 1:1 and equal to and less than 4:1.

Herein, the silicon source of the step (a) is selected from one and more of Fumed Silica, silica sol, silica gel, fine silica, and quartz powder.

Also, the carbon source is characteristically selected from one and more of a monomer including Carbon Black, carbon-nano tube, fullerene, phenol resin, franc resin, xylene resin, polyimide, polyurethane, polyacrylonitrile, polyvinyl alcohol, and poly acetic acid vinyl, prepolymer, cellulose, manufactured sugar, pitch, and tar.

Also, a heating temperature of the step (b) is characteristically equal to or larger than 1600° C. and equal to and less than 1900° C.

Also, a heating time of the step (b) is characteristically 3 hours.

In particular, the silicon carbide pulverulent body manufacturing method further includes, between the step (a) and the step (b), the step of heating the mixture and carbonizing carbon sources contained in the mixture.

Herein, the carbonizing step is characterized by carbonizing at a temperature of equal to or larger than 700° C. and equal to and less than 1200° C.

Also, the carbonizing step is characterized by carbonizing at a temperature of equal to or larger than 900° C. and equal to and less than 1100° C.

Also, a silicon carbide pulverulent body manufacturing system of the present invention, characteristically includes a mixer producing a mixture consisting of silicon sources and carbon sources; and a sealed crucible synthesizing silicon carbide (SiC) by heating the mixture at a vacuum degree of equal to or larger than 0.03 torr and equal to and less than 0.5 torr, and at a temperature of 1300° C. and more and 1900° C. and less.

Also, a mass ratio of the silicon sources and the carbon sources is characteristically equal to and more than 1:1 and equal to and less than 4:1.

Also, the silicon source is Fumed Silica, and the carbon source is carbon black.

Also, a heating temperature of the crucible is characteristically 1600° C. and more and 1900° C. and less.

Also, the heating time is characteristically 30 minutes to 5 hours.

In particular, the silicon carbide pulverulent body manufacturing system further includes a carbonizer carbonizing carbon sources contained in the mixture by heating the mixture.

Also, the carbonizer characteristically carbonizes a temperature of 700° C. and more and 1,200° C. and less.

Also, the carbonizer characteristically carbonizes a temperature of 900° C. and more and 1,100° C. and less.

In addition, the present invention is related to a silicon carbide pulverulent body manufacturing method, including the step (a) of producing a silicon carbide raw material mixture by mixing SiO powder and carbon sources in a mixer; and the step (b) of obtaining silicon carbide pulverulent body by heat-processing the mixture at a temperature of 1,400° C. and over and 1,700° C. and less and for 30 minutes and over and 7 hours and less in a crucible.

Also, the carbon source of the step (a) is characteristically carbon black.

Also, in the step (a), a mixing ratio of carbon versus silicon is characteristically 1.3 and over and 1.8 and less.

Also, the step (a) uses a ball mill as a mixer, characterized by the step of producing a silicon carbide mixture by mixing SiO, carbon sources, and balls for a ball mill.

In particular, between the step (a) and the step (b), the method further includes the step (1) of recovering a silicon carbide mixture by filtering the balls for a ball mill out using a sieve.

Also, between the step (a) and the step (b), the method further includes the step (2) of measuring the recovered mixture in a graphite crucible.

Also, the crucible material in the step (b) is graphite, characterized by filling vacuum or inert gas in an inner space.

### Advantageous Effects of Invention

The present invention can be manufactured compared to an existing silicon carbide pulverulent body manufacturing method at low pressure and low temperature, can save a process cost and easily obtain high-purity silicon carbide pulverulent body.

The present invention can lower a temperature and shorten time in a heat-processing process in the synthesis of silicon carbide pulverulent body, and enhance a recovery ratio of silicon carbide pulverulent body over a general silicon compound use process.

### BRIEF DESCRIPTION OF DRAWINGS

FIG. 1 is a block diagram of a silicon carbide pulverulent manufacturing method according to one preferred embodiment of the invention;

FIG. 2 is a construction block diagram of a silicon carbide pulverulent manufacturing system according to one preferred embodiment of the invention; and

FIG. 3 is a flow chart of a silicon carbide pulverulent body manufacturing method according to another preferred embodiment of the invention.

### BEST MODE FOR CARRYING OUT THE INVENTION

Hereinafter, a silicon carbide pulverulent body manufacturing method and system according to one preferred embodiment will be demonstrated in detail in consideration of the annexed drawings. However, in describing the embodiments, a specific description about related well-known functions or constructions will be omitted in a case it is determined to make the substance of the present invention unnecessarily obscure.

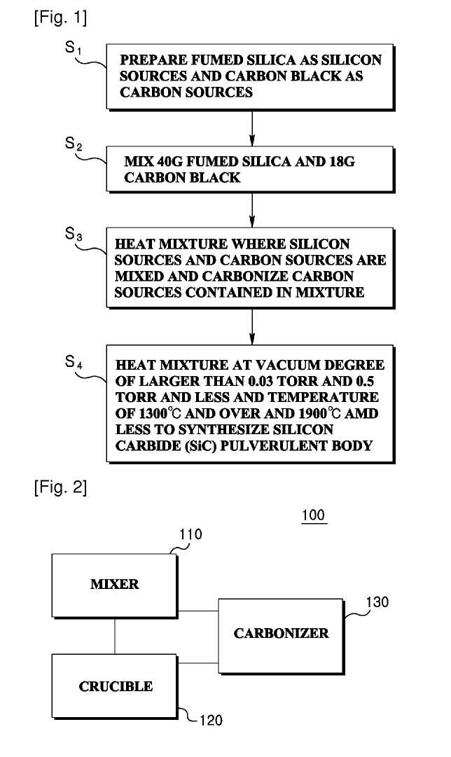

FIG. 1 is a block diagram of a silicon carbide pulverulent body manufacturing method according to one preferred embodiment of the present invention.

Referring to FIG. 1, first silicon sources and carbon sources are prepared, particularly it is desirable to make preparations of fumed silica as the silicon sources and carbon black as the carbon sources (S1). However, the silicon sources and carbon sources are limited to those mentioned, but silica sol, SiO₂ (silica gel), fine silica, quartz powder may be used as the silicon sources.

Also, as the carbon sources, solid carbon such as carbon-nano tube, fullerene or organic compounds having a higher remaining carbon ratio, for example, monomer or prepolymer such as phenol resin, franc resin, xylene resin, polyimide, polyurethane, polyacrylonitrile, polyvinyl alcohol and poly acetic acid vinyl, cellulose, manufactured sugar, pitch, tar, and their mixtures may be used.

Thereafter, such silicon sources and carbon sources are mixed. Particularly, 40 g of fumed silica as the silicon sources and 18 g of carbon black as the carbon sources are mixed (S2). Here, in a case solid carbon sources are used, a mass ratio of silicon sources and carbon sources is desirable to be 1:1 and over and 4:1 and less.

Also, the use of organic carbon sources requires carbon sources having about 2 times mass over solid carbon sources, but liquid carbon sources may have somewhat differences based on carbon yield produced during a later carbonization procedure. And next, a mixture where silicon sources and carbon sources are mixed is heated, and thus carbon sources contained in the mixture is carbonized (S3).

The carbonization process is desirable to be at a temperature of 700° C. and over and 1200° C. and less. Also, it is more desirable to maintain a temperature of the carbonization process at 900° C. and over and 1100° C. and less, and in a case carbon sources not being organic carbon material, the carbonization process can be omitted.

Afterward, the mixture is heated at a vacuum degree of larger than 0.03 torr and 0.5 torr and less and a temperature of 1300° C. and over and 1900° C. and less to synthesize silicon carbide (SiC) pulverulent body (S4).

Herein, a heating time is desired to be 30 minutes to 5 hours but not necessarily limited to this.

Also, a heating temperature is more desirable to be 1600° C. and over and 1900° C. and less. Also, a synthetic process condition is desirable to have 1 torr of a vacuum degree, and it is more desirable to perform a heat-processing at a vacuum atmosphere of 0.1 torr and less.

However, a case of the vacuum degree being 0.03 torr and less is undesirable for the following reasons. A mechanical load is much consumed in mass-production equipment; additional equipment is needed; equipment is difficult to maintain; and the accompanying cost is high.

By the use of such a process of the invention, high-purity silicon carbide pulverulent body may be manufactured at a low-cost. Such an effect is indicated in Table 1 below compared to a case an existing method is used.

TABLE 1

| | Impurity Content (ppm) | | |
|---|---|---|---|
| | comparison example | first example | second example |
| B | 0.1 | 0.1 | 0.1 |
| Na | 5 | 0.01 | 0.5 |
| k | 2 | 0.01 | 0.5 |
| Al | 3 | 0.5 | 1 |
| Cr | 1 | 0.1 | 0.1 |
| Fe | 1 | 0.1 | 0.1 |
| Ni | 1 | 0.1 | 0.5 |
| Cu | 0.1 | 0.1 | 0.1 |
| W | 1 | 0.1 | 0.5 |
| Ti | 0.05 | 0.05 | 0.05 |
| Ca | 10 | 0.5 | 1 |

Referring to FIG. 1, a comparison example indicates a case of producing silicon carbide pulverulent body in an existing way. And, a first example and a second example are cases of producing silicon carbide pulverulent body using a manufacturing method according to the present invention. Here, a common condition in all cases is that 40 g of fumed silica having 40 nm average diameter as silicon sources is selected and 18 g of carbon black with 20 nm average diameter as carbon sources is selected in order to a mixing process and a carbonization process is omitted.

Also, as a difference, the comparison example shows one of synthesizing for 3 hours at a temperature of 1700° C., under Argon (Ar) gas ambient in a crucible. On the other hand, a first example is one of synthesizing at a vacuum degree of 0.1 torr and over and 0.5 torr and less in a crucible, at 1700° C. and for 3 hours, and a second example is one of synthesizing at a vacuum degree of 0.1 torr and over and 0.5 torr and less in a crucible, at 1600° C. and for 3 hours.

As shown from a test result, impurity content of a first example and a second example is significantly small over a comparison example. Thus, the use of the present invention can save a manufacturing cost and obtain high-purity silicon carbide pulverulent body having much less impurity by using a vacuum state instead of the use of argon gas.

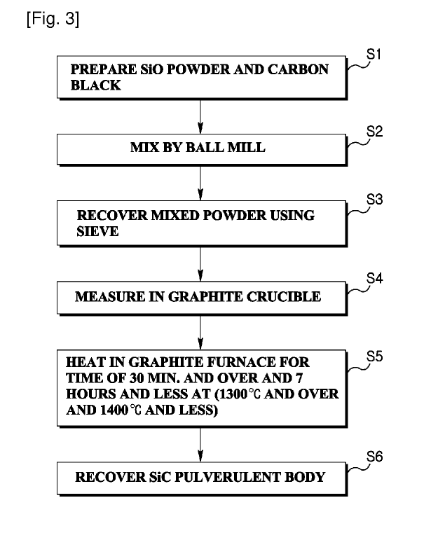

FIG. 2 is a construction block diagram of a silicon carbide pulverulent body manufacturing system according to one preferred embodiment of the present invention.

A silicon carbide pulverulent body manufacturing system 100 includes a mixer 110, a crucible 120, and a carbonizer 130. A mixer mixes silicon sources and carbon sources to produce a mixture comprised of the silicon sources and the carbon sources. Here, the silicon sources and carbon sources may be selected from various kinds as described in FIG. 1. Particularly, a mass ratio of silicon sources and carbon sources is desirable to be 1:1 and over and 4:1 and less. Also, a carbonizer 130 is coupled to a mixer 110 and a crucible 120 and a crucible 120, and carbonizes carbon sources contained in a mixture. Also, a temperature carbonized at a carbonizer 130 is preferably 700° C. and over and 1200° C. and less, more preferably carbonizes at 900° C. and over and 1100° C. and less. Particularly, a carbonizer 130 can be omitted in the case of mixture's carbon sources not being organic carbon material, and this case, a mixture from a mixer 110 moves directly to a crucible 120.

Also, a crucible 120 heats a mixture at a vacuum degree of larger than 0.03 torr and 0.5 torr and less and at a temperature of 1300° C. and over and 1900° C. and less to synthesize silicon carbide (SiC) pulverulent body. Particularly, a heating temperature of a crucible is more desirable to be 1600° C. and over and 1900° C. and less. Also, a heating time in a crucible 130 is desirable to be 3 hours.

The aforementioned silicon carbide pulverulent body manufacturing system can manufacture low-cost and high-purity silicon carbide pulverulent body.

FIG. 3 is a flow chart of a silicon carbide pulverulent body manufacturing method according to another preferred embodiment of the invention.

Referring to FIG. 3, SiO powder and carbon black are prepared (S1).

SiO is in-process material of SiO₂ and C. Here, carbon black is used as carbon sources but not necessarily limited to this. For example, solid carbon such as carbon-nano tube, fullerene or organic compounds having a higher remaining carbon ratio, in detail, monomer or prepolymer such as phenol resin, franc resin, xylene resin, polyimide, polyurethane, polyacrylonitrile, polyvinyl alcohol and poly acetic acid vinyl, cellulose, manufactured sugar, pitch, tar, and their mixtures may be used.

Such prepared SiO powder and carbon black powder are mixed into a mixer, that is, a ball mill (S2). Here, a mixing ratio of SiO and C is theoretically most ideal when a ratio of C:Si is 2:1. However, because SiO is actually volatized while gassificated, a ratio of C:Si is desirable to be 1.3:1 and over and 1.8:1 and less. Also, in order to prevent the clot of silicon carbide pulverulent body mixed in a ball mill, balls for a ball mill are mixed together. Such balls for a ball mill can use a nylon ball, a urethane ball, a teflon ball and the like.

Thereafter, silicon carbide raw material powder mixed in a ball mill is recovered using a sieve (S3). Here, a sieve may use a metal sieve or a poly-sieve. Balls for a ball mill are filtered out using such a sieve and a silicon carbide pulverulent body may be recovered only.

And next, a silicon carbide pulverulent body raw material mixture filtered out at S3 is measured in a graphite crucible (S4). A reason for measurements is to understand a manufacturing efficiency by measuring the amount of a final silicon carbide raw material mixture entered into a heating furnace.

And next, silicon carbide pulverulent body is synthesized by heating in a graphite furnace for the time of 30 min. and over and 7 hours and less at a temperature of 1400° C. and over and 1700° C. and less (S5).

A synthesis procedure of silicon carbide pulverulent body taken place within such a graphite furnace is presented as in Reaction 1 below.

ChemistryFigure 1

SiO+C→Si+CO

Si+C→SiC

. . . . . . . . .

SiO+2C→SiC+CO Chem.1

In this case, the inner part of a graphite furnace is filled with vacuum or inert gas (for example, argon (Ar), hydrogen (H), etc.).

Thereafter, silicon carbide pulverulent body is finally recovered (S6).

Improved facts pursuant to the present invention described above are indicated in Table 2 below.

TABLE 2

| | Comparison Example | Example |
|---|---|---|
| Temperature | 1650° C. | 1400° C. |
| Time | 5 | 3 |
| Recovery ratio | 30% | 53% |
| Grain size (D50) | 1.4 μm | 1.3 μm |

Referring to Table 2, a comparison example indicates a prior art, for silicon compound SiO₂ is used, and for carbon compound carbon black is used. These mixtures are comprised of a ratio of 2.5:1 smaller than 3:1, that is a theoretical mixture ratio of the existing SiO₂ and C in a ball mill. Also, a SiC crystal peak is confirmed therein by XRD (X-ray diffraction) after 5-hour heat-processing at 1650° C. in a crucible.

Also, the example uses SiO as a silicon compound and carbon black as a carbon compound by a manufacturing process according to the invention. This mixture of C:Si is mixed at a ratio of 1.8:1 by C:Si in a ball mill. Also, after 3-hour heat-processing at 1400° C. in a crucible, a SiC crystal peak is confirmed therein by XRD.

As shown from a test result, the present invention has lowered a heating temperature by 200° C. from 1650° C. to 1400° C. and shortened a time by 2 hours. Also, a recovery ratio of silicon carbide pulverulent body has ratchets up from 30% to 50%, and in a grain size (D50) also, finer pulverulent body may be obtained from 1.4 μm to 1.3 μm.

Thus, a higher recovery ratio and a fine silicon carbide pulverulent body due to a more efficient process may be obtained.

As described above, the present invention has been described in detail with regard to specific embodiments. However, various modifications could be made without departing from the scope of the present invention. The spirit of the present invention technology should not be understood in a limiting sense to the described embodiments of the invention, but must be defined as claims as well as the equivalents to such assertions.

### INDUSTRIAL APPLICABILITY

The present invention can provide a silicon carbide pulverulent body manufacturing method and system capable of being manufactured by a low pressure and a low temperature and saving a process cost.

1. A silicon carbide pulverulent body manufacturing method, characterized by:
a step (a) of producing a mixture consisting of silicon sources and carbon sources in a mixer; and
a step (b) of synthesizing silicon carbide (SiC) pulverulent body by heating the mixture at a vacuum degree of larger than 0.03 torr and equal to and less than 0.5 torr and at a temperature of equal to or larger than 1300° C. and equal to and less than 1900° C.

2. The method as claimed in claim 1, wherein in the step (a), a mass ratio of the silicon sources and the carbon sources is equal to and more than 1:1 and equal to and less than 4:1.

3. The method as claimed in claim 2, characterized in that the silicon source of the step (a) is selected from one and more of Fumed Silica, silica sol, silica gel, fine silica, and quartz powder, wherein the carbon source is selected from one and more of a monomer including carbon black, carbon-nano tube, fullerene, phenol resin, franc resin, xylene resin, polyimide, polyurethane, polyacrylonitrile, polyvinyl alcohol, and poly acetic acid vinyl, prepolymer, cellulose, manufactured sugar, pitch, and tar.

4. The method as claimed in claim 1, characterized in that the method, between the step (a) and the step (b), further includes heating the mixture and carbonizing carbon sources contained in the mixture.

5. The method as claimed in claim 4, characterized in that the carbonizing step includes carbonizing at a temperature of equal to or larger than 700° C. and equal to and less than 1200° C.

6. A silicon carbide pulverulent body manufacturing method, characterized by:
a step (a) of producing a silicon carbide raw material mixture by mixing of SiO powder and carbon sources in a mixer; and
a step (b) of obtaining silicon carbide pulverulent body by heat-processing the mixture at a temperature of 1,400° C. and more and 1,700° C. and less and for 30 minutes and over and 7 hours and less in a crucible.

7. The method as claimed in claim 6, characterized in that in the step (a), the carbon source is carbon black.

8. The method as claimed in claim 7, characterized in that the step (a), a mixing ratio of carbon (C) versus silicon (Si) is 1.3 and over and 1.8 and less.

9. The method as claimed in claim 1, characterized in that the method, between the step (a) and the step (b), further includes a step (1) of recovering a silicon carbide mixture by filtering the balls for a ball mill out using a sieve; and
a step (2) of measuring the recovered mixture in a graphite crucible, wherein the step (a) uses a ball mill as a mixer, characterized by the step of producing a silicon carbide mixture by mixing SiO, carbon sources, and balls for a ball mill.

10. The method as claimed in claim 9, characterized in that the heating furnace material in the step (b) is graphite, by filling vacuum or inert gas in an inner space.

11. A silicon carbide pulverulent body manufacturing system, characterized by:
a mixer producing a mixture consisting of silicon sources and carbon sources; and
a sealed crucible synthesizing silicon carbide (SiC) by heating the mixture at a vacuum degree of equal to or larger than 0.03 torr and equal to and less than 0.5 torr, and at a temperature of 1300° C. and over and 1900° C. and less.

12. The system as claimed in claim 11, characterized in that a mass ratio of the silicon sources and the carbon sources is equal to and more than 1:1 and equal to and less than 4:1.

13. The system as claimed in claim 11, characterized in that the silicon source is selected from one and more of Fumed Silica, silica sol, silica gel, fine silica, and quartz powder, wherein the carbon source is characteristically selected from one and more of a monomer including carbon black, carbon-nano tube, fullerene, phenol resin, franc resin, xylene resin, polyimide, polyurethane, polyacrylonitrile, polyvinyl alcohol, and poly acetic acid vinyl, prepolymer, cellulose, manufactured sugar, pitch, and tar.
